(19) United States
(12) Patent Application Publication
(10) Pub. No.: US 2012/0049526 A1
(43) Pub. Date: Mar. 1, 2012

(54) Energy recovery system (E.R.S.)

(76) Inventor: Mathew Michael Raio, Fillmore, CA (US)

(21) Appl. No.: 12/807,238

(22) Filed: Sep. 1, 2010

(51) Int. Cl. H02K 7/18

(52) U.S. Cl. 290/52

(57) ABSTRACT

The Energy Recovery System (E.R.S), is designed to use the following custom devices (rotor, keyed coupler, generator, housing unit) to extract small slices of work and use it's energy to ‘bank’ for future use. The general design is simple, and scalable for all current and future infrastructures that utilizes pressurized systems of air, gas, and liquid systems.

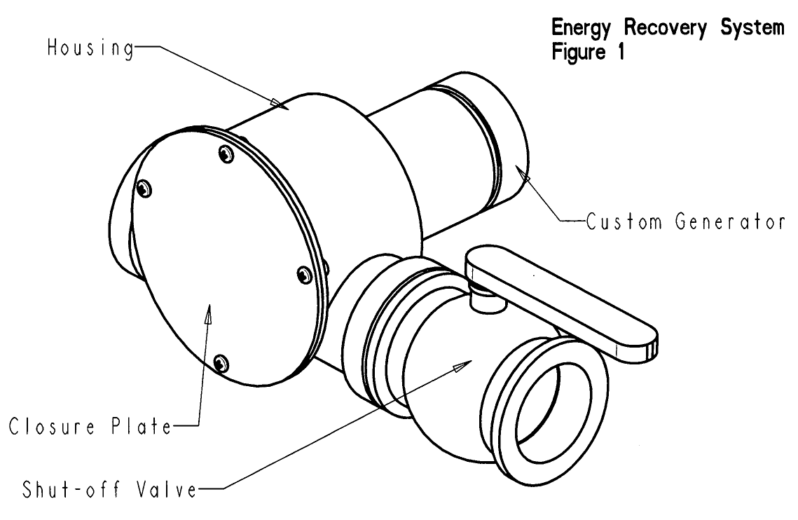

FIG. 1: Is a 3D view of an “ENERGY RECOVERY SYSTEM” showing my new design.

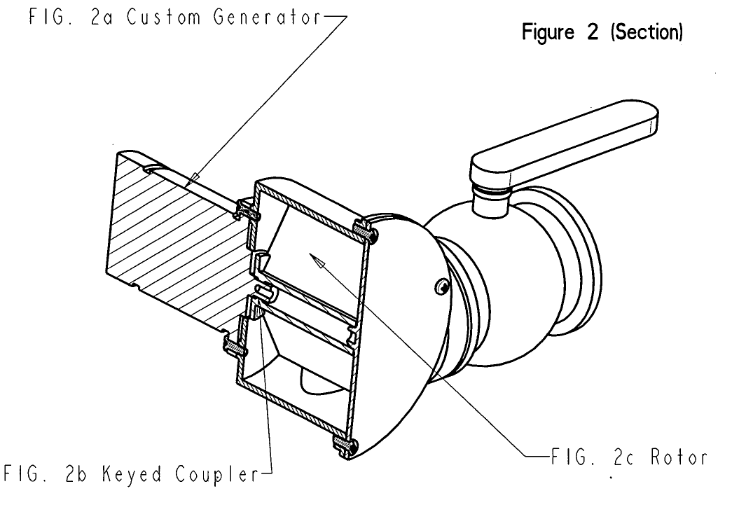

FIG. 2: Is a 3D view of the “ENERGY RECOVERY SYSTEM” with a cutaway view exposing the following; a.) custom generator, b.) keyed coupler, c.)rotor.

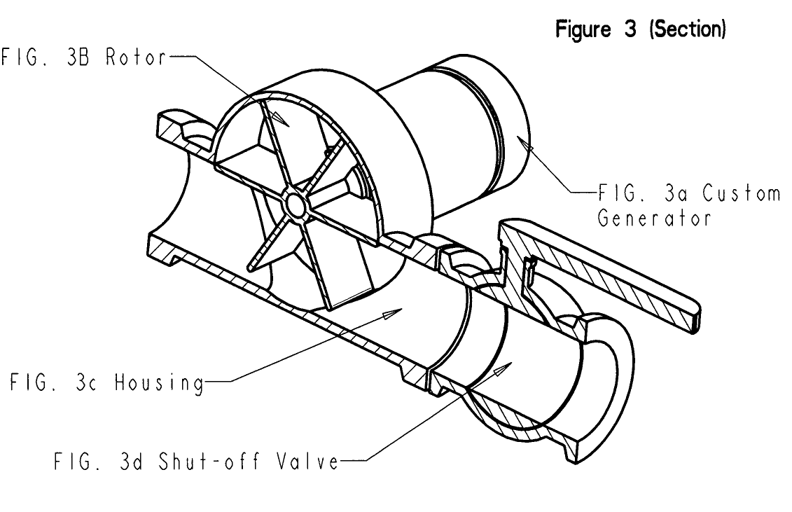

FIG. 3: Is a 3D view of an “ENERGY RECOVERY SYSTEM” with a ‘cutaway’ view exposing the following; a.) custom generator, b.) rotor, c.) housing, d.) shut off valve

*Changes made in bold—MR

NOTE: the ‘keyed coupler’ is critical to this patent claim. The keyed coupler will enable in the simple design the means of converting very small ‘slices’ of work, into tangible, small electrical current.

The keyed coupler device, consists of the following elements:
I. The notched drive shaft from the generator, inserted into the rotor.
II. The rotor will have a corresponding shape that will do two things.
   a. Stabilize the generator within its own mounted housing unit.
   b. Fitted to maximize the conversion of work from the rotor to electrical current within the generator.

Mathematically speaking, a force applied to mass, (either gas, liquid, or air), is the cost of conversion. HOWEVER, if a pressurized system creates work, and the material (in lbs, per square inch) is GREATER than the Energy Recovery System's ability to convert ALL the work, we have two interesting points. . . .
1. The pressurized system, will experience a temporary load from the Energy Recovery System. The rotor on a drive shaft with a ball bearing on the other end, will now rotate without hindrance to the material flow of (air, gas, or water).
2. The Energy Recovery System will now be extracting exactly the amount of current based on the limitation of the design itself.

This is critical to understand. And the application is subtle and moderate. But the inventor feels it will be effective on multiple levels.
Scenario 1: The home user.
   I. Although the system does not replace conventional supplies of electricity, to have an auxiliary supply generated from everyday use of gas, yields an industry designed to create a ‘smart grid’. In the event of an attack by a foreign sovereignty, the home user, will have the capacity to use stored energy via cell technology. The time spent building up that stored electrical current is during a time of peace while the home owner needs little knowledge of this ‘banking’ of small amounts of current over a protracted amount of months, days and years. In this design, the E.R.S, is sporadic and not constant. It will recover small amounts of electrical current based on the home owner's use of utilities. The more a home consumes, the more it saves.
Scenario II: The military, utility, corporation entity . . . known as CONGLOMERATES.
   I. This E.R.S., can simply be placed into existing infrastructures in key areas to ‘light’ underground passages, or create depots of saved electrical current in cells. I do not need to elaborate on the benefits if the system has a constant, maintained flow: The point is, somewhere down the line of the pressurized system, there is rather a build up of energy based on inertia and gravitational forces. Placing an E.R.S, to extract very small amounts of work, WILL NOT IMPEDE on the system as a whole and will yield numerous BENEFITS, from conserving such industrious efforts.
Scenario III: The ‘energy farmer’.
   I. There is a growing desire to capitalize on certain ‘green’ programs by receiving copious amounts of revenue, backed by the United States Government. This system can also apply to a rapid rise in using free standing METHANE digesters in reclamation plants of waste and water facilities. The METHANE DIGESTER, is also useful in converting waste in horse ranches and other agrarian enterprises.
      a. When properly designed and applied, the E.R.S, can take the converted work and re-apply the conserved energy back into the operation of a methane digester, or power a very small electrical circuit.

NOTE: By my rough estimates, a METHANE DIGESTER, that I have designed can yield over a two week period, 44 lbs per square inch, of methane, in a 1¼ inch pipe. This would convert to 3 kgs per square inch at the point of the rotor. It is here where the ‘magic in moderation’ happens. Based on the limitations of the E.R.S, it can only extract what it can possibly convert. Therefore, a free standing energy source, although cumbersome to operate, can also generate adequate amounts of energy stored in cell technology. I recommend contacting M.I.T., which already has the photosynthesis aspect

1: I, Mathew Raio (Inventor), claim the ornamental design for an Energy Recovery System as described and shown in following figures to be unique in it's whole (the rotor, the keyed coupler, and custom generator) and it's application.

2: I, Mathew Raio (Inventor), claim the keyed coupler between the rotor and the custom generator to be unique in the E.R.S. (Energy Recovery System, and is scalable for all future improvements.

3: I, Mathew Raio (Inventor), claim this Energy Recovery System's general application in all pressurized systems of air, gas, or liquid and is NOT limited to modification of existing or future manufactured devices, or personal home use, but also extends to municipalities, utilities, organizations and environmental applications either in existing facilities, products, or newer ‘greener’ technologies such as METHANE digester, or other waste/water/oil/gas recovery/reclamation systems.
